(19) United States
(12) Patent Application Publication
(10) Pub. No.: US 2006/0170627 A1
(43) Pub. Date: Aug. 3, 2006

(54) Method and apparatus for taking a reading of a sensor coupled to a light emitting element of a flat panel display

(76) Inventors: W. Edward Naugler JR., Cedar Park, TX (US); Sriram Ramamurthy, San Jose, CA (US); Robert Warren Sherburne JR., Kentfield, CA (US)

Correspondence Address: HOWREY LLP, C/O IP DOCKETING DEPARTMENT, 2941 FAIRVIEW PARK DRIVE, SUITE 200, FALLS CHURCH, VA, 22042-2924, US

(21) Appl. No.: 11/331,380

(22) Filed: Jan. 12, 2006

Related U.S. Application Data
(60) Provisional application No. 60/644,676, filed on Jan. 12, 2005.

(51) Int. Cl. G09G 3/30

(52) U.S. Cl. 345/76

(57) ABSTRACT

The present invention discloses an OLED display having a first row of light emitting diodes and a second row of light emitting diodes. A first sensor circuit is coupled to a light emitting diode of the first linear array for detecting an output of the light emitting diode of the first linear array. A second sensor circuit is coupled to a light emitting diode of the second linear array for detecting an output of the light emitting diode of the second linear array. A control circuit simultaneously causes the light emitting diode of the first linear array to emit light and the sensor circuit coupled to the light emitting diode of the second linear array to provide information corresponding to the detected output of the light emitting diode of the second linear array to a sensor reader circuit.

### RELATED APPLICATION

This application claims the benefit of U.S. Provisional Application No. 60/644,676, filed Jan. 12, 2005, which is incorporated herein by reference.

### FIELD OF INVENTION

The present invention relates to flat panel displays, specifically to feedback systems for stabilizing emissions of flat panel displays.

### BACKGROUND OF THE INVENTION

Nuelight Corporation, the assignee of the present invention, has many pending patent applications that disclose emission stabilization techniques for emissive flat panel displays. The patent application numbers are U.S. Pat. Nos. 11/016357, 11/016137, 11/016686, 11/016164, 11/0156638 and 11/016372, and they are incorporated herein by reference. These applications disclose optical sensor feedback systems that compensate for the thin film transistor (TFT) drift and the aging characteristics of organic light emitting diodes (OLED). The OLED technology is being developed and implemented in new flat panel displays.

FIG. 1 illustrates a technique disclosed in the above applications. FIG. 1 shows an exemplary pixel circuit 10 having two rows (Row N and Row N+1) of pixel circuitry. The first row of circuitry includes the driver circuit 20 and the sensor circuit 30. The driver circuit 20 includes the TFT T1, the capacitor C1, TFT T2 and the OLED D1. The driver circuit 20 controls the emission of the OLED D1. The sensor circuit 30 includes the sensor S1, the TFT T3 and the capacitor C2. The sensor circuit detects or senses the emission of the OLED D1 and stores the information corresponding to the detected emission using the capacitor C2.

The horizontal line enable conductor 40 (labeled Row N select) to is used to enable the downloading of the data voltage to drive the current source (TFT T1) for the OLED D1, and to simultaneously activate the TFT T3 of the sensor circuit 30. Conductor line 40 is connected to the gates of T1 and T3. Line 40 supplies enabling voltages to the gates of both T1 and T3. When both T1 and T3 are activated, the sensor line 50, which is coupled to the sensor circuit 30, is first read by a sensor reader circuit and then the data voltage is downloaded to the OLED current source T1, C1 and T2 by using the conductor column driver line 60 coupled to the driver circuit 20.

The row address time, which is the amount of time for which conductor line 40 activates T1 and T3, is used to perform two operations, in which the sensor S1 is first read out and then the new voltage data is down loaded to the driver circuit 20. The time duration of the row address is determined by the frame rate and the number of lines (or rows) of pixel circuitry on the display. Thus, for a 1000 line display running at 60 frames per second (fps), the row address time is 16.67 microseconds less the horizontal retrace time. The horizontal retrace time is the time between the ending of the writing of data to one row to the beginning of the writing of data to the next row. The horizontal retrace time can be 5 to 10 microseconds leaving only 6.67 to 11.67 microseconds to do both sensor reading and voltage data down loading.

The arrangement of FIG. 1 can cause delays because of gate the line 40 impedance. In other words, it takes time to turn on the gate enabling line 40 due to the line capacitance (C) and line resistance (R) causing a significant RC time constant. The present invention solves that problem.

### SUMMARY OF THE INVENTION

The present invention discloses a display having a first linear array of light emitting elements and a second linear array of light emitting elements. A first sensor circuit is coupled to a light emitting element of the first linear array for detecting an output of the light emitting element of the first linear array. A second sensor circuit is coupled to a light emitting element of the second linear array for detecting an output of the light emitting element of the second linear array. A control circuit simultaneously causes the light emitting element of the first linear array to emit light and the sensor circuit coupled to the light emitting element of the second linear array to provide information corresponding to the detected output of the light emitting element of the second linear array to a sensor reader circuit.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 illustrates a pixel circuit wherein the gate enable line simultaneously energizes both the data TFT and the sensor TFT;

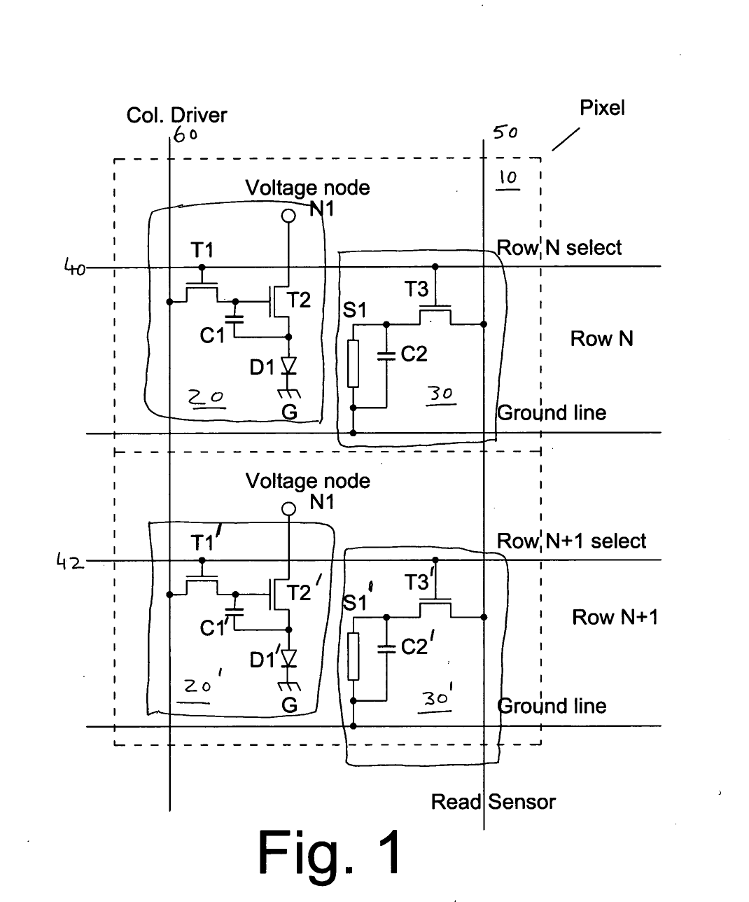

FIG. 2 illustrates an exemplary pixel circuit of the present invention wherein the gate enable line for the data TFT for Row N is also the gate enable line for the sensor TFT for Row N+1; and

FIG. 3 illustrates an exemplary timing diagram for driving the display of the present invention.

### DETAILED DESCRIPTION OF THE INVENTION

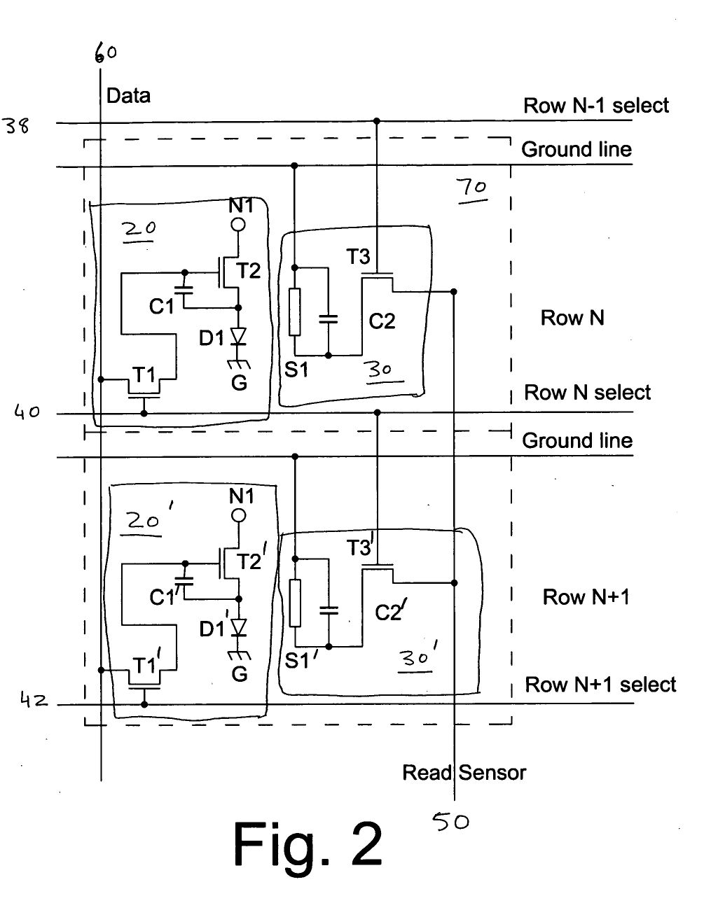

FIG. 2 shows the pixel circuitry 70 of the present invention. In order to simultaneously read the sensor S1 and download data in a way that the new voltage data for the OLED D1 does not interfere with the sensor S1 measurement, the new data is downloaded to the driver circuit 20 while the sensor S1′ of the sensor circuit 30′ in the row labeled N+1 is read. That is, the gate line 40 for enabling the data TFT T1 is also connected as the gate enabling line 40 for the sensor TFT T3′ of the sensor circuit 30′ in the row N+1.

In FIG. 2, Row N select line 40 is shown running between the two rows. The gate of T1 in Row N is connected to the Row N gate select line 40 and the gate of T3′ in Row N+1 is also connected to the same Row N select line 40. When Row N select line 40 is activated, T1 in Row N and T3′ in Row N+1 are turned on; and therefore new voltage data for the OLED in Row N is passed to the gate of T2 and capacitor C1, while simultaneously the sensor S1′ data for Row N+1 stored on C2′ in Row N+1 is passed to the sensor read circuit by the read sensor line 50 independently of the changing OLED emission in Row N.

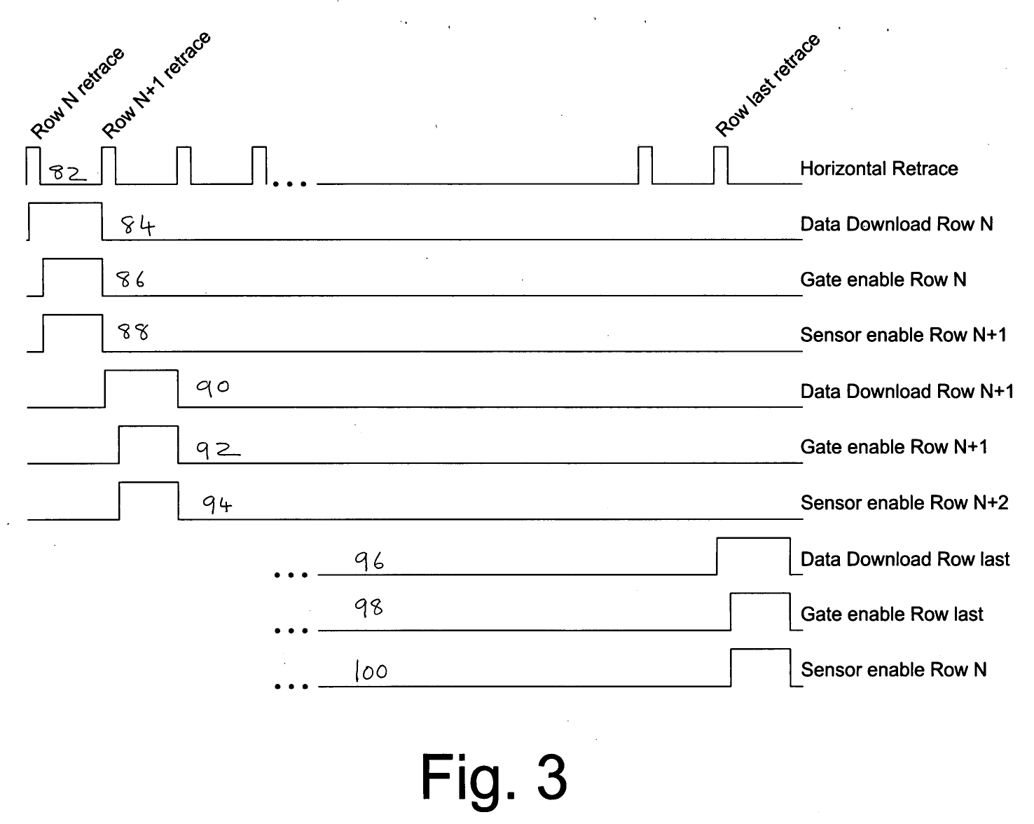

FIG. 3 shows timing diagrams for operating the circuit. The top timing line 82 is the horizontal retrace pulse chain. The one of ordinary skill in the art will appreciate that the actual timing is determined by the frame rate and number of lines in the display. The relative times are shown by the spatial distances of the pulses.

Note that in this embodiment the data download 84 from the column driver 60 to the data transistors T1 begins slightly after the retrace time begins. At the end of the retrace pulse 82 the gate enable pulse for Row N 86 begins and since the gate enable line 40 for Row N is also the gate enable line 40 for the sensor S1′ in Row N+1, the pulse for sensor enable Row N+1 88 begins at the same time.

Both gate enable pulses 86 and 88 end at the beginning of the next retrace pulse 82 for Row N+1. This process continues until the last row (line) in the display has been downloaded, as is shown by the timing waveforms 90, 92, 94, 96, 98 and 100. Note that the pulse for the gate enable for last row 98 corresponds with the sensor enable pulse for the top row 100, which is Row N. In one embodiment, an extra horizontal conducting line runs along the top of the display and accesses the gates of all the T3s in the first row. This line is coupled to a vertical line conductor running between this top sensor gate line and the bottom data gate line for the last row.

The present invention can be implemented in the following embodiments: active matrix backplanes using amorphous silicon as the channel semiconductor; active matrix backplanes using poly silicon as the channel semiconductor; active matrix backplanes using crystalline silicon as the channel semiconductor; active matrix backplanes employing a direct sensor measurement during the address time; active matrix backplanes employing an integration period for the sensor of one frame or a fraction of a frame or for several frames or for any number of frames; active matrix display using any emissive materials including OLEDs, EL devices, plasma, and electron beam activated phosphors or vacuum fluorescent displays; active matrix backplanes of any number of lines or columns; active matrix backplanes in any geometrical configuration including rectilinear and circular; active matrix backplanes on any substrate including metal, glass, plastic ridged or flexible; sensors using any optically active material including amorphous silicon, poly silicon, crystalline silicon, cadmium selenide, OLED material; sensors that are passive; sensors that are active; sensors in any circuit configuration; and displays employed in any use including computer monitors, entertainment systems, and any system requiring or using a device for visual graphics or read outs.

1. A display comprising:
a first linear array of light emitting elements;
a second linear array of light emitting elements;
a first sensor circuit coupled to a light emitting element of the first linear array for detecting an output of the light emitting element of the first linear array;
a second sensor circuit coupled to a light emitting element of the second linear array for detecting an output of the light emitting element of the second linear array; and
a control circuit for simultaneously causing the light emitting element of the first linear array to emit light and the sensor circuit coupled to the light emitting element of the second linear array to provide information corresponding to the detected output of the light emitting element of the second linear array to a sensor reader circuit.

2. The display of claim 1, wherein the display includes a liquid crystal display.

3. The display of claim 1, wherein the light emitting element is selected from the group consisting of a light emitting diode and an organic light emitting diode.

4. The display of claim 1, wherein the control circuit for turning on the light emitting element of the second linear array before turning on the light emitting element of the first linear array.

5. The display of claim 1, further comprising:
a storage device for storing information corresponding to the detected output of the light emitting diode of the second linear array.

6. The display of claim 5, wherein the storage device includes a capacitor.

7. The display of claim 1, wherein the first and second linear arrays include two rows of light emitting elements.

8. The display of claim 7, wherein the first linear array is situated horizontally above the second linear array.

9. The display of claim 8, further comprising:
the light emitting element of the first linear array is situated directly above the light emitting element of the second linear array; and
the light emitting element of the second linear array is coupled to a second sensor circuit.

10. The display of claim 1, further comprising:
the control circuit for simultaneously turning on every light emitting diode of the first linear array.

11. A method for a display comprising:
causing a first light emitting element to emit light;
detecting the light emitted by the first light emitting element;
storing information corresponding to the detected light for the first light emitting element; and
causing a second light emitting diode to emit light and simultaneously providing the information corresponding to the detected light for the first light emitting element to a sensor reader circuit.

12. A display comprising:
a matrix including a plurality of rows of pixel circuits;
a first row of the matrix including a first plurality of light emitting elements coupled to a first plurality of driver circuits and a first plurality of sensor circuits;
a second row of the matrix including a second plurality of light emitting elements coupled to a second plurality of driver circuits and a second plurality of sensor circuits;
every driver circuit of the first and second plurality of driver circuits including a switch for activating a light emitting element;
every sensor circuit of the first and second plurality of sensor circuits including a sensor for detecting light emission of a light emitting diode, an information storage unit and a switch for providing information about the detected light to a reader circuit;
a row select electrical conductor line coupled to the switches of the first plurality of driver circuits and to the switches of the second plurality of sensor circuits; and
the row select electrical conductor for simultaneously turning on the switches of the first plurality of driver circuits and the switches of the second plurality of sensor circuits.

13. The display of claim 12, wherein the switch includes a thin film transistor.

14. The display of claim 13, wherein the row select electrical conductor line for simultaneously turning on the switches by simultaneously applying the same voltage to the gate of the thin film transistors.

15. The display of claim 12, wherein the storage unit includes a capacitor.

16. The display of claim 12, wherein the first row is situated directly above the second row.

17. The display of claim 12, wherein the light emitting element is selected from a group consisting of a light emitting diode and an organic light emitting diode.

18. The display of claim 12, wherein the display includes a liquid crystal display.

19. The display of claim 12, wherein the sensor can be fabricated using an optically active material selected from the group consisting of amorphous silicon, poly silicon, crystalline silicon, cadmium selenide and organic light emitting diode material.

20. The display of claim 12, wherein the matrix is implemented as an active matrix.
